(19) United States
(12) Patent Application Publication
(10) Pub. No.: US 2021/0312388 A1
(43) Pub. Date: Oct. 7, 2021

(54) EARLY LIFECYCLE PRODUCT MANAGEMENT

(71) Applicant: INTERNATIONAL BUSINESS MACHINES CORPORATION, Armonk, NY (US)

(72) Inventors: YINGJIE LI, CHAPPAQUA, NY (US); AJAY ASHOK DESHPANDE, PLEASANTVILLE, NY (US); ALI KOC, WHITE PLAINS, NY (US); HERBERT MCFADDIN, YORKTOWN HEIGHTS, NY (US); CHRISTOPHER SCOTT MILITE, SOUTHBURY, CT (US); JAE-EUN PARK, WAPPINGERS FALLS, NY (US); BRIAN QUANZ, YORKTOWN HEIGHTS, NY (US); YADA ZHU, IRVINGTON, NY (US)

(21) Appl. No.: 16/839,197

(22) Filed: Apr. 3, 2020

(51) Int. Cl. G06Q 10/08; G06Q 30/02; G06N 20/00

(52) U.S. Cl. CPC G06Q 10/0837; G06N 20/00; G06Q 30/0202; G06Q 10/0838

(57) ABSTRACT

Aspects of the invention include obtaining product hierarchy information for an early lifecycle product offered for sale by a retailer and obtaining order data for each order of the early lifecycle product during an early lifecycle period. The aspects also include obtaining customer data for a customer associated with each order of the early lifecycle product during the early lifecycle period and determining an expected return rate for the early lifecycle product based by inputting the product hierarchy information, the order data and the customer data into a trained return prediction model. Aspects also include performing an action based on a stored profile of the retailer based on a determination that the expected return rate exceeds a threshold value.

### BACKGROUND

The present invention generally relates to product management, and more specifically, to early lifecycle product management.

E-commerce retail business has grown in the double digits in recent years, with sales projected to reach four trillion by 2020. To remain competitive, retailers employ hassle-free return policies to improve customer satisfaction and buying. However, e-commerce customer returns provide a huge challenge for retailers and significantly cut into profits. Numerous studies have found returns occur for about one-third of all e-commerce orders, and 50% return rates are typical for more expensive items, e.g., higher-end fashion items. Combined with these high return rates, generous return policies lead to reduced profit margins and even prevent some retailers from being profitable Product returns incur significant costs to retailers including direct costs such as shipping, re-stocking, and re-furbishing; and indirect ones such as increased call center load, reduced customer satisfaction and lifetime value, and sub-optimal inventory management. In many retail industries, products have short seasons and high product turn over. For example, in retail fashion, new products can be introduced daily and the full price seasons last only a couple of months from the introduction of the product. In these industries, there is a very short time window to determine new products' return characteristics and address returns and return costs.

### SUMMARY

Embodiments of the present invention are directed to early lifecycle product management. A non-limiting example computer-implemented method includes obtaining product hierarchy information for an early lifecycle product offered for sale by a retailer and obtaining order data for each order of the early lifecycle product during an early lifecycle period. The method also includes obtaining customer data for a customer associated with each order of the early lifecycle product during the early lifecycle period and determining an expected return rate for the early lifecycle product based by inputting the product hierarchy information, the order data and the customer data into a trained return prediction model. The method further include performing an action based on a stored profile of the retailer based on a determination that the expected return rate exceeds a threshold value.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a flow diagram of a method for early lifecycle product management according to one or more embodiments of the present invention;

FIG. 2 depicts a block diagram of a database having a set of rules for selecting an action based on an expected return rate according to one or more embodiments of the present invention;

FIG. 3 depicts a cloud computing environment according to one or more embodiments of the present invention;

FIG. 4 depicts abstraction model layers according to one or more embodiments of the present invention; and

FIG. 5 illustrates a processing system for linking copied code according to one or more embodiments of the present invention.

The diagrams depicted herein are illustrative. There can be many variations to the diagrams, or the operations described therein without departing from the spirit of the invention. For instance, the actions can be performed in a differing order or actions can be added, deleted or modified. Also, the term “coupled”, and variations thereof describes having a communications path between two elements and does not imply a direct connection between the elements with no intervening elements/connections between them. All of these variations are considered a part of the specification.

### DETAILED DESCRIPTION

One or more embodiments of the present invention provide methods, systems, and computer program products for early lifecycle product management. In accordance with one or more embodiments of the present invention, a return prediction model is created based on historical data of the sales of a retailer. The return prediction model is created by using one of several known machine learning techniques. During an early lifecycle period in which a new product is offered for sale by the retailer, data regarding the product being offered, data regarding orders that include the new product, and data regarding the customers that bought the new product are input into the return prediction model and an expected return rate for the new product is determined. In exemplary embodiments, newly acquired data is continually inputted into the model throughout the early lifecycle period and the expected return rate is updated. In exemplary embodiments, if the expected return rate is above a threshold value one or more actions are automatically performed based on a stored profile of the retailer.

In exemplary embodiments, the early lifecycle product management system enables retailers to evaluate how a new product is predicted to perform in terms of return rate after only a few days or weeks into its season, and take appropriate actions to reduce their costs. For example, investigating and taking corrective actions for high return rate products like re-shooting product images or fixing website descriptions, or adjusting marketing campaigns or customer options around products given their predicted return rates, or adjusting inventory management and operations such as replenishment plans and staffing for returns processing. In exemplary embodiments, the early lifecycle product management system is configured to identify non-standard indicative characteristics of orders from early in the season for new products to predict the full season return rate, leveraging machine learning to weight and quantify the impact and importance of these characteristics for predicting return rates.

In exemplary embodiments, the early lifecycle product management system is configured to identify and use unique elements such as, customer behavior and basket characteristics, and does not rely solely on the transaction history (i.e., returns seen so far) to predict return rates for newly released products. The the early lifecycle product management system leverages these other types of information and derives predictions based off of these atypical characteristics derived from the characteristics of the orders seen for the product so far (as opposed to just observed returns which are extremely limited early on). For example, when a new product is being purchased early on mostly by customers with a history of high return rate, the early lifecycle product management system early lifecycle product management system will predict that the product will have a high return rate. The early lifecycle product management system exploits these new return prediction ideas (addressing the case of predicting for new products) and uses machine learning to automatically predict a expected return rate for a new product. The early lifecycle product management system predicts return rates largely, or in some cases entirely, from order information alone (without actually seeing any returns or seeing only very few).

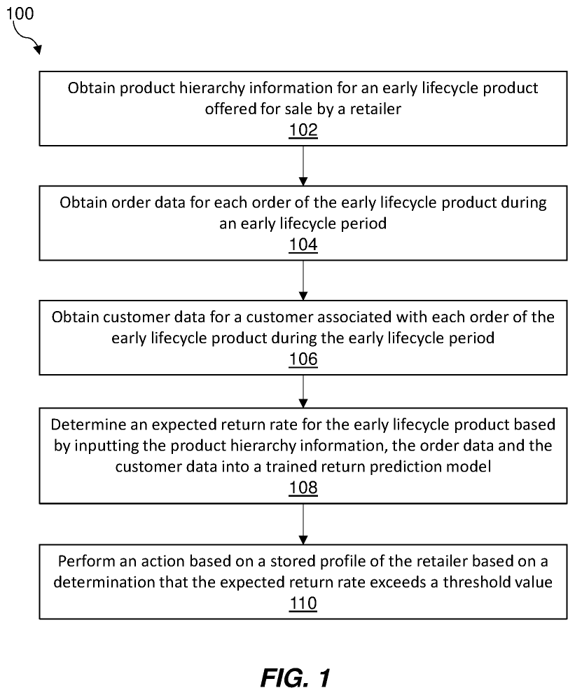

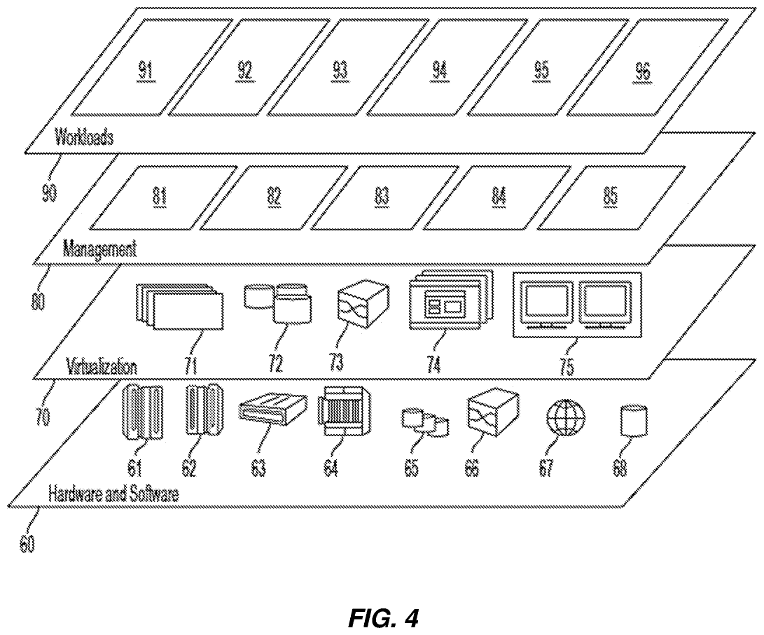

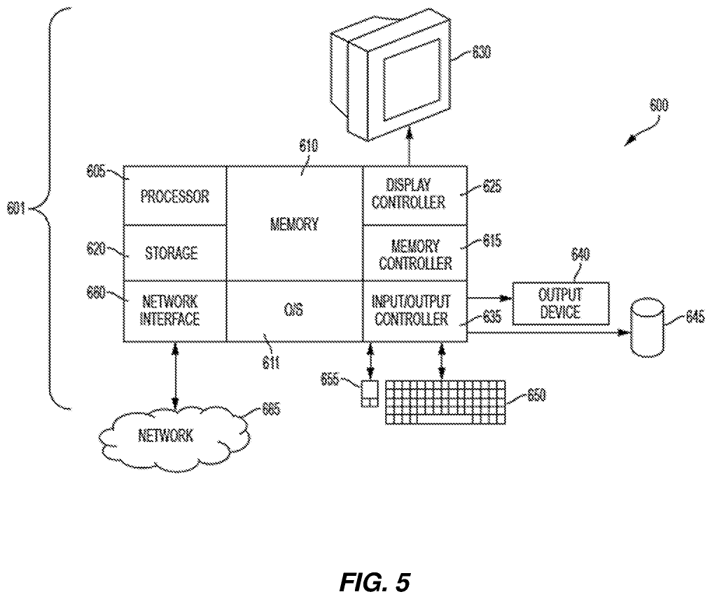

Turning now to FIG. 1, a flow diagram of a method 100 for early lifecycle product management is generally shown in accordance with one or more embodiments of the present invention. The method 100 shown in FIG. 1 may be executed by an operating system, such as OS 611 of FIG. 5, executing on a computer processor. The computer processor can be a standalone processor or a node in a cloud, such as node 10 in FIG. 4.

As shown at block 102, the method 100 includes obtaining product hierarchy information for an early lifecycle product offered for sale by a retailer. In retail, products are typically organized into a product hierarchy with the lowest level containing each individual unique product up to higher levels with increasingly wider categories including that product. For example, a fashion retailer might have a womens division, further divided into a number of sub-divisions and target groups (e.g., active or regular), then classes (e.g., knit sweaters), subclasses (e.g., long sleeve), styles (e.g., modern cut pullover), colors (e.g, black), and sizes (e.g., small). In clothing retail, the lowest level (down to the size) the article and the level above it with the color are referred to as the “style-color” of the product. For simplicity, throughout this disclosure, the terminology for the product hierarchy fashion use case is used. However, the disclosed methods and systems are applicable to other domains and product hierarchies as well.

Next, as shown at block 104, the method 100 includes obtaining order data for each order of the early lifecycle product during an early lifecycle period. The order data includes an identification of the product sold, an identification of other items included in the order, the cost of each item in the order, the size of each item in the order, the order date, and the like. The method 100 also includes obtaining customer data for a customer associated with each order of the early lifecycle product during the early lifecycle period, as shown at block 106. In exemplary embodiments, the customer data includes the prior order and return history of the customer. In one embodiment, the customer data includes demographic and economic data of the customer.

In exemplary embodiments, the early lifecycle period is a percentage of a time period in which the retailer will sell the early lifecycle product at full price. In one example, a fashion retailer sells a newly released product at full price for ten weeks and the early lifecycle period is twenty percent of the full price period, i.e., two weeks. In exemplary embodiments, the length of the time period in which the retailer will sell the early lifecycle product at full price and the percentage of that time period that represents the early lifecycle period will vary depending upon the type of retailer and the characteristics of the products being sold.

Next, as shown at block 108, the method 100 includes determining an expected return rate for the early lifecycle product based by inputting the product hierarchy information, the order data and the customer data into a trained return prediction model. In exemplary embodiments, the trained return prediction model is created by applying a machine-learning algorithm to a set of features extracted from a set of historical data for the retailer. In one example, a machine learning algorithm extracts a set of feature vectors associated with historical orders to create a feature space of the trained return prediction model. The feature vectors associated with orders of the early lifecycle product are then input into the trained return prediction model and mapped to the feature space and an expected return rate is calculated.

In exemplary embodiments, the historical data includes historical order data, historical customer data, and product hierarchy information for all products included in the historical order data. The set of features includes return and order quantity features, seasonality features, product category identifiers, product variability features, order characteristic features, order profile features, and customer profile features.

Next, as shown at block 110, the method 100 includes performing an action based on a stored profile of the retailer based on a determination that the expected return rate exceeds a threshold value. In exemplary embodiments, the stored profile of the retailer includes a plurality of actions and a set of rules for selecting the action from the plurality of actions. The plurality of actions include, but are not limited to, changing a price of the early lifecycle product, removing the early lifecycle product from a website of the retailer, instituting a review of a product listing of the early lifecycle product on the website of the retailer, and updating images of the early lifecycle product on the website. In exemplary embodiments, the set of rules for selecting the action from the plurality of actions includes an identification of which of the plurality of actions to take based on the expected return rate and optionally one or more of a sales price and a profit margin of the early lifecycle product.

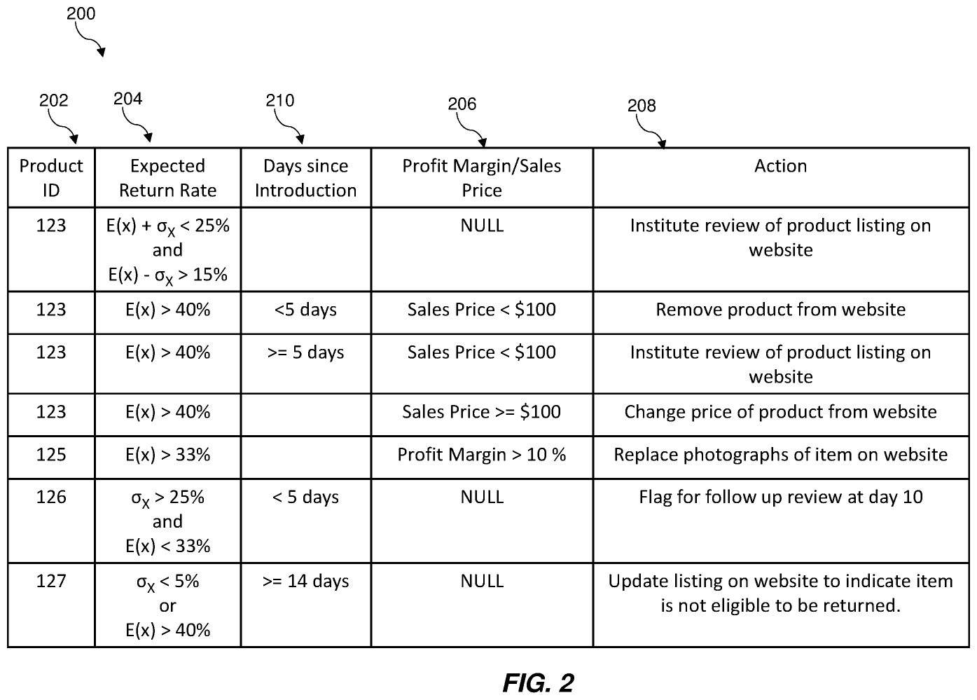

FIG. 2 depicts a block diagram of a database 202 having a set of rules for selecting an action based on an expected return rate according to one or more embodiments of the present invention. As illustrated, each entry the database 200 includes a product identification number 202, an expected return rate threshold value or range 204, a profit margin/sales price 206, and an indication of the action 208 to take when the conditions for that entry are met. In exemplary embodiments, the entry in the database also includes a number of days 210 since the early lifecycle product has been offered for sale.

In exemplary embodiments, a user can utilize the expected return rate threshold value or range 204 in the database entry to specify a wide range of conditions for executing the desired action. In one example, the expected return rate threshold value or range 204 can require that the expected return rate, E(x), be above or below a specified value. In another example, the the expected return rate threshold value or range 204 can require that the expected return rate, E(x) plus a standard deviation of the expected return rate, σ_{X}, be above or below a specified value. In a further example, the the expected return rate threshold value or range 204 can require that a standard deviation of the expected return rate, σ_{X}, be above or below a specified value.

In exemplary embodiments, a user can utilize the number of days 210 since the early lifecycle product has been offered for sale to further customize the conditions needed for executing the desired action. For example, a user may wish to take a different action if the expected return rate is above a specified level in the first two days of selling an item rather than if the expected return rate is above the same level after two weeks of selling the item. Accordingly, a user can utilize the various fields in the database to determine when to take different desired actions throughout the early life of the product—i.e., at each time point in the early life period.

In one example, after the first day the new product is released for sale, a retailer can use the early lifecycle product management system to get predictions of return rates, along with associated uncertainty in the form of prediction intervals (hi/low such as predicted rate is 80% with a low of 60% and high of 90%, for example). This can already trigger some decisions early on, and as more data comes in on day 2, day 3, etc., other decisions may be triggered, especially as those uncertainty intervals correspondingly shrink.

In one embodiment, as shown with reference to product ID 126 in FIG. 2, when the standard deviation of the expected return rate greater than is greater than twenty-five percent (σ_{X}>25%) and the expected return rate less than one third, the action would be to wait an re-evaluate after the product has been for sale for ten days. In other cases, the retailer might take different actions, such as preferring to no longer offer returns if it has been greater than two weeks from the introduction of the product and return rate is predicted to be high with low uncertainty.

In exemplary embodiments, the trained return prediction model receives a set of k features {x ⱼ|∈1 . . . k} that are used to predict the full-season return rate y for the new product. The set of k features are characteristics are derived and computed from only the data available in the early lifecycle period. For example, one feature might be the number of orders in the early lifecycle period and another might be the day of the year. The return rate y is computed as the fraction of products that are ordered in the time period in which the retailer will sell the early lifecycle product at full price, referred to herein as the full season, that are eventually returned at some future date. More specifically,

$$y = {\sum }_{o ∈ O} {1}_{R} ( o \text{)/\textbar} O \vert ,$$

where O is the set of all individual ordered items in the full season, and 1_{R}(o) indicates if item o was returned at some future date. In this formulation as a prediction task, each new product becomes a single data point. Each data point has a number of derived features xⱼ combined into a feature vector ^{\vec{ }}x, and the machine learning problem is to then learn a function mapping ^{\vec{ }}x to a prediction of the return rate y, given a sample of cases (^{\vec{ }}x and y pairs).

In exemplary embodiments, data obtained from the orders placed during an early lifecycle period provides a wealth of information about expected product returns, even without any actual return data. Leveraging these order-level return indicators, e.g., for the case of fashion, whether or not there are multiple sizes and colors of the same style in the order, product-level indicators are created based on the orders during an early lifecycle period. In exemplary embodiments, the return rate y is defined as

$$y = {\sum }_{i = 0}^{m} \frac{{n}_{i}}{n} {r}_{i}$$

where rᵢ is the historic rate of return for a style-color when i other products of the same style are ordered with it, nᵢ is the number of such orders in the early lifecycle period for the target style color, and n is the total number of orders for that style-color. Note it would also be necessary to truncate this series due to the limited number of orders, e.g., taking the rate and proportions for three or more substitutable items included in the order. A similar approach can be done based on, or in combination with, customer type proportions. However, rather than implement a fixed formula that may not account for various uncertainties and inaccuracies, these proportions are treated as features and machine learning is used to quantify the precise relationship between these features and the return rate. For example, a decision tree could group cases with single items in the same style into a node using these features and use the historic return rate for those cases, but then it could further adjust its prediction as well with other variables to arrive at a better prediction.

In exemplary embodiments, various features are extracted from the historical order data, the customer data and the product hierarchy. One feature is return and order quantity, for example, return rates and return and sales quantities, computed in different time periods and at different aggregate levels in the product hierarchy. Another feature is seasonality, such as the day of year, month of year, etc. Further features include product category identifiers, e.g., features indicating which product category is part of and product variability,—e.g., the number of different variations of the product, different sizes and colors. Other features include order/basket characteristics, e.g., the average, maximum and minimum price of items in the order including the product. Further features include order profile, e.g., the proportion of orders including the new product that has more than one variation of the same product, i.e., the same item in a different size or color. Other features include customer profile features, e.g., the average past return rate for customers ordering the style-color in the early lifecycle period. In exemplary embodiments, hundreds of features are extracted and used to train the return prediction model.

Based on the computed features, a set of feature vectors and label pairs is created, {\vec{ }xᵢ,yᵢ|i=1 . . . n}. To find a function to predict y matching our sample data, a loss function L is defined between a predicted value of y, ŷ=f(\vec{ }x), and y, for example, squared error: L(y,ŷ)=(y−ŷ)². A function f that minimizes this loss is then identified using one of a variety of known machine learning techniques, such as gradient boosting and deep learning (DL). Both gradient boosting and deep learning are similar in that they essentially represent a combination of multiple, simpler functions. Gradient boosting model is a weighted sum of individual regression trees, fit incrementally. Whereas the DL model is a sequence of compositions of simple functions, where all of the function parameters are fit at the same time. One advantage of using the loss gradient-based optimization approaches of gradient boosting and deep learning is that alternative loss functions can be easily substituted. As a result, prediction intervals using quantile regression using a quantile loss can be generated (i.e., tilted absolute value of the error), L_{q}, per case as the loss function, and minimizing the mean quantile loss

$$\frac{1}{n} {{Σ}^{n}}_{i = 1} {L}_{q} ( {y}_{i} , \hat{y} ) .$$

Here q is the quantile between 0 and 1 and L_{q} is given by Equation 1:

L_{q}(y,ŷ)=max(q(y,ŷ),(q−1)(y−ŷ)) (1)

To obtain the prediction interval, models are built for each quantile used in the interval, e.g., 0.9 and 0.1 as upper and lower quantiles respectively. There are a number of general techniques for determining feature importance that can be applied to any machine learning method to determine the relative feature importances or rankings, for instance, wrapper methods such as recursive feature elimination. The gradient boosting tree model already has a standard, built-in way to estimate relative feature importance. Feature importance is estimated from the trained boosted decision tree model based on how much each feature contributes to reducing the approximation error on the training cases.

In experimental data reviewed, the top categories of features included: past return rates for different product hierarchy levels and time windows; basket prices and quantities, e.g., summary characteristics of orders baskets containing the product in the early lifecycle period; seasonality, e.g., time period in the year; customers history, e.g., past return behavior of customers ordering the style-color in the early lifecycle period; early lifecycle period returns, e.g., returns that happened in the early lifecycle period—at different levels in the product hierarchy; and style and order options, e.g., characteristics of the different options (sizes and colors) in a style, and in the orders in the early lifecycle period with that style-color. Interestingly, the feature category that generally had the least importance was the product division the style-color belonged to (e.g., “Brand A Casual Women” vs. “Brand B Trend Men”), suggesting that the representation captured by the other features generalizes well enough across the different divisions that division-specific models are not necessary.

Although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

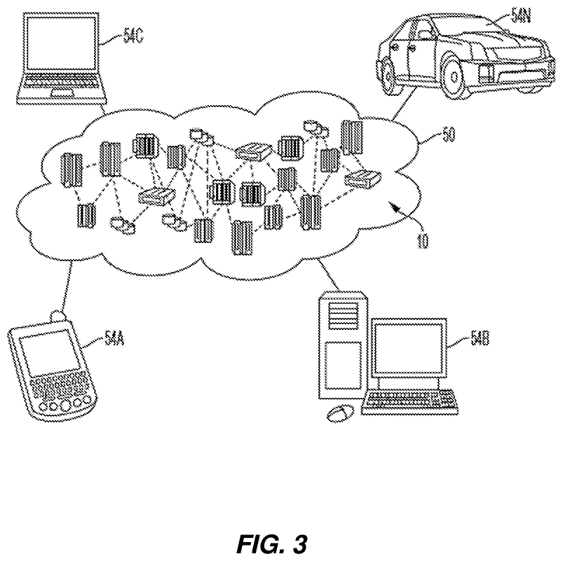

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and early lifecycle product management 96.

It is understood that one or more embodiments of the present invention are capable of being implemented in conjunction with any type of computing environment now known or later developed.

Turning now to FIG. 5, a computer system is generally shown in accordance with one or more embodiments of the present invention. The methods described herein can be implemented in hardware, software (e.g., firmware), or a combination thereof. In one or more exemplary embodiments of the present invention, the methods described herein are implemented in hardware as part of the microprocessor of a special or general-purpose digital computer, such as a personal computer, workstation, minicomputer, or mainframe computer. The system 600 therefore may include general-purpose computer or mainframe 601 capable of running multiple instances of an O/S simultaneously.

In one or more exemplary embodiments of the present invention, in terms of hardware architecture, as shown in FIG. 5, the computer 601 includes one or more processors 605, memory 610 coupled to a memory controller 615, and one or more input and/or output (I/O) devices 640, 645 (or peripherals) that are communicatively coupled via a local input/output controller 635. The input/output controller 635 can be, for example but not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The input/output controller 635 may include a plurality of sub-channels configured to access the output devices 640 and 645. The sub-channels may include fiber-optic communications ports.

The processor 605 is a hardware device for executing software, particularly that stored in storage 620, such as cache storage, or memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, and/or other types of storage media. Note that the memory 610 can have a distributed architecture, where various components are situated remote from one another, but can be accessed by the processor 605.

The instructions in memory 610 may include one or more separate programs, each of which comprises an ordered listing of executable instructions for implementing logical functions. In the example of FIG. 5, the instructions in the memory 610 a suitable operating system (OS) 611. The operating system 611 essentially controls the execution of other computer programs and provides scheduling, input-output control, file and data management, memory management, and communication control and related services.

In accordance with one or more embodiments of the present invention, the memory 610 may include multiple logical partitions (LPARs) each running an instance of an operating system. The LPARs may be managed by a hypervisor, which may be a program stored in memory 610 and executed by the processor 605.

In one or more exemplary embodiments of the present invention, a conventional keyboard 650 and mouse 655 can be coupled to the input/output controller 635. Other output devices such as the I/O devices 640, 645 may include input devices, for example but not limited to a printer, a scanner, microphone, and the like. Finally, the I/O devices 640, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630.

In one or more exemplary embodiments of the present invention, the system 600 can further include a network interface 660 for coupling to a network 665. The network 665 can be an IP-based network for communication between the computer 601 and any external server, client and the like via a broadband connection. The network 665 transmits and receives data between the computer 601 and external systems. In an exemplary embodiment, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 601 is a PC, workstation, intelligent device or the like, the instructions in the memory 610 may further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute instructions stored within the memory 610, to communicate data to and from the memory 610, and to generally control operations of the computer 601 pursuant to the instructions. In accordance with one or more embodiments of the present invention, computer 601 is an example of a cloud computing node 10 of FIG. 4.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for early lifecycle product management the method comprising:
obtaining product hierarchy information for an early lifecycle product offered for sale by a retailer;
obtaining order data for each order of the early lifecycle product during an early lifecycle period;
obtaining customer data for a customer associated with each order of the early lifecycle product during the early lifecycle period;
determining an expected return rate for the early lifecycle product based by inputting the product hierarchy information, the order data and the customer data into a trained return prediction model; and
based on a determination that the expected return rate exceeds a threshold value, performing an action based on a stored profile of the retailer.

2. The computer-implemented method of claim 1, wherein the trained return prediction model is created by applying a machine learning algorithm to a set of features extracted from a set of historical data for the retailer.

3. The computer-implemented method of claim 2, wherein the historical data includes historical order data, historical customer data, and product hierarchy information for all products included in the historical order data.

4. The computer-implemented method of claim 2, wherein the set of features comprise return and order quantity features, seasonality features, product category identifiers, product variability features, order characteristic features, order profile features, and customer profile features.

5. The computer-implemented method of claim 1, wherein the early lifecycle period is a percentage of a time period in which the retailer will sell the early lifecycle product at full price.

6. The computer-implemented method of claim 5, wherein the expected return rate is an expected return rate during the time period in which the retailer will sell the early lifecycle product at full price.

7. The computer-implemented method of claim 1, wherein the stored profile of the retailer includes a plurality of actions and a set of rules for selecting the action from the plurality of actions.

8. The computer-implemented method of claim 7, wherein the plurality of actions include:
changing a price of the early lifecycle product;
removing the early lifecycle product from a website of the retailer;
instituting a review of a product listing of the early lifecycle product on the website of the retailer; and
updating images of the early lifecycle product on the website.

9. The computer-implemented method of claim 7, wherein the set of rules for selecting the action from the plurality of actions includes an identification of which of the plurality of actions to take based on the expected return rate and one of a sales price and a profit margin of the early lifecycle product.

10. A system comprising:
one or more processors for executing computer-readable instructions, the computer-readable instructions controlling the one or more processors to perform operations comprising:
obtaining product hierarchy information for an early lifecycle product offered for sale by a retailer;
obtaining order data for each order of the early lifecycle product during an early lifecycle period;
obtaining customer data for a customer associated with each order of the early lifecycle product during the early lifecycle period;
determining an expected return rate for the early lifecycle product based by inputting the product hierarchy information, the order data and the customer data into a trained return prediction model; and
based on a determination that the expected return rate exceeds a threshold value, performing an action based on a stored profile of the retailer.

11. The system of claim 10, wherein the trained return prediction model is created by applying a machine learning algorithm to a set of features extracted from a set of historical data for the retailer.

12. The system of claim 11, wherein the historical data includes historical order data, historical customer data, and product hierarchy information for all products included in the historical order data.

13. The system of claim 11, wherein the set of features comprise return and order quantity features, seasonality features, product category identifiers, product variability features, order characteristic features, order profile features, and customer profile features.

14. The system of claim 10, wherein the early lifecycle period is a percentage of a time period in which the retailer will sell the early lifecycle product at full price.

15. The system of claim 14, wherein the expected return rate is an expected return rate during the time period in which the retailer will sell the early lifecycle product at full price.

16. The system of claim 15, wherein the stored profile of the retailer includes a plurality of actions and a set of rules for selecting the action from the plurality of actions.

17. The system of claim 16, wherein the plurality of actions include:
changing a price of the early lifecycle product;
removing the early lifecycle product from a website of the retailer;
instituting a review of a product listing of the early lifecycle product on the website of the retailer; and
updating images of the early lifecycle product on the website.

18. The system of claim 17, wherein the set of rules for selecting the action from the plurality of actions includes an identification of which of the plurality of actions to take based on the expected return rate and one of a sales price and a profit margin of the early lifecycle product.

19. A computer program product comprising a computer-readable storage medium having program instructions embodied therewith, the program instructions executable by a processor to cause the processor to perform operations comprising:
obtaining product hierarchy information for an early lifecycle product offered for sale by a retailer;
obtaining order data for each order of the early lifecycle product during an early lifecycle period;
obtaining customer data for a customer associated with each order of the early lifecycle product during the early lifecycle period;
determining an expected return rate for the early lifecycle product based by inputting the product hierarchy information, the order data and the customer data into a trained return prediction model; and
based on a determination that the expected return rate exceeds a threshold value, performing an action based on a stored profile of the retailer.

20. The computer program product of claim 19, wherein the trained return prediction model is created by applying a machine learning algorithm to a set of features extracted from a set of historical data for the retailer.
